(19) United States
(12) Patent Application Publication
(10) Pub. No.: US 2012/0289618 A1
(43) Pub. Date: Nov. 15, 2012

(54) PREPARATION METHOD OF CLAY/POLYMER COMPOSITE USING SUPERCRITICAL FLUID-ORGANIC SOLVENT SYSTEM

(75) Inventors: Youngmee JUNG, Seoul (KR); Soo Hyun Kim, Seoul (KR); Sang-Heon Kim, Seoul (KR); Purba Purnama, Gyeonggi-Do (KR)

(73) Assignee: KOREA INSTITUTE OF SCIENCE AND TECHNOLOGY, Seoul (KR)

(21) Appl. No.: 13/276,793

(22) Filed: Oct. 19, 2011

(30) Foreign Application Priority Data
May 12, 2011 (KR) 10-2011-0044812

(51) Int. Cl. C08J 9/35; C08L 81/00; C08L 67/04; C08L 69/00; C08J 3/205; C08K 3/34

(52) U.S. Cl. 521/91; 524/445; 524/447

(57) ABSTRACT

The present invention relates to a method for preparing a clay/polymer composite having a predetermined form such as powder or porous foam with an enhanced thermal and mechanical stability using a simple, economical and eco-friendly supercritical fluid-organic solvent system, and more particularly, to a method for preparing a clay/biodegradable polymer stereoisomeric nanocomposite and a clay/polymer composite prepared by the method thereof. The method of preparing a clay/polymer composite according to the present invention may include (a) introducing a clay, a biodegradable single-phase D-type/L-type stereoisomeric polymer and an organic solvent into a reactor, (b) introducing a supercritical fluid into the reactor to form a stereoisomeric composite, and forming a clay/polymer composite dispersed with the clay on the stereoisomeric composite, and (c) collecting the clay/polymer composite, and the clay/polymer composite of the present invention is a clay/polymer composite prepared by the preparation method.

### RELATED APPLICATION

This application claims the benefit of Korean Patent Application No. 10-2011-0044812, filed on May 12, 2011, which is hereby incorporated by reference for all purposes as if fully set forth herein.

### BACKGROUND OF THE INVENTION

1. Field of the Invention

The present invention relates to a method for preparing a clay/polymer composite having a predetermined form such as powder or porous foam with an enhanced thermal and mechanical stability using a simple, economical and eco-friendly supercritical fluid-organic solvent system, and more particularly, to a method for preparing a clay/biodegradable polymer stereoisomeric nanocomposite and a clay/polymer composite prepared by the method thereof.

2. Background of the Invention

As plastic based on petroleum becomes a principal cause of environmental pollution due to the difficulty of decomposition and concern over an exhaustion of petroleum resources has been increased, there has been an increased interest in applying reproducible natural resources such as starch, pectin, protein, and the like to food packages requiring biodegradability and solubility. Biodegradable polymer materials have been mainly used in various fields such as medicine, agriculture, environment, and the like due to their unique decomposition property, and particularly their value in the environment and medicine fields has been drastically increased. The polymer can be classified into a natural biodegradable polymer and a synthetic biodegradable polymer. Of them, the raw materials of the natural biodegradable polymer are natural substances and thus they have been recognized as potent substances because of having a high affinity to environment, and high physical performance and adaptability to life, but have a disadvantage of requiring high cost and causing difficulty that cannot be easily manipulated due to the properties of natural substances.

On the contrary, the commercial value of the synthetic biodegradable polymer has been highly evaluated over recent years in the aspect of capable of artificially manipulating and complementing the poor properties of the natural biodegradable polymer. Particularly, polyactide (PLA), among the synthetic biodegradable polymers, has been used for various applications in the environment and medicine fields because of its relatively excellent performance and affinity and non-toxicity to life, and the like. In particular, it has been used for noteworthy applications such as a disposable packaging film, an agricultural and industrial film, a food packaging container, and the like in the environment field, and has already been developed and used for a drug delivery system (DDS) for controlled release of drugs, bones and tissue fixation pins, screws, sutures, and the like in the medicine field. Furthermore, studies on increasing thermal and mechanical stability of the biodegradable polymer have been also carried out to use them in applications such as automobile part materials and industrial materials.

On the other hand, studies on the development of new materials have been carried out in the direction of developing eco-friendly products as well as for the purpose of enhancing the functionality of the products. Accordingly, the industrial requirement for new materials has been increased to satisfy such several conditions.

A stereoisomeric composite of the polymer forms a new crystalline structure when two kinds of single-phase polymers having different enantiomorphic stereo phases are dissolved or uniformly mixed above a predetermined temperature by applying an organic solvent, thereby obtaining an excellent property such as thermal and mechanical stability higher than that of a single-phase polymer. Particularly, the property and performance of a product using stereoisomeric composites can be drastically enhanced, and the “use-by” date can be extended, thereby reducing an amount of waste matter and preventing environmental pollution. Stereoisomeric composites may be used in various application fields including automotive, packaging, and semiconductor industries, as well as food, medicine, telecommunications and military fields, according to a kind of polymer and a molecular weight of the used polymer. Furthermore, in addition to the foregoing method, nanocomposites prepared by using a very small amount of nanomaterial may be also a new material to meet the need of high-tech industries. A clay/nanocomposite dispersed with a chemistry of nano-sized layered clay on a matrix polymer may result in improved properties such as significantly enhanced thermal resistance, high rigidity, high barrier, nonflammability, and the like without increasing a small amount of specific gravity and decreasing an impact strength compared to conventional composites using an inorganic filler such as mica, talc, or the like. Such significantly enhanced properties have been well known in the example of a nanocomposite made of alkyl quaternary ammonium modified bentonite clay and polyamides, which is currently used as an automotive timing gear belt cover (U.S. Pat. Nos. 4,810,734, 4,889,885, 4,894,411 and 5,385,776). Until now, in the method for preparing a high molecular nanocomposite using a high molecular stereoisomer or clay, there has been a problem in the limitation of a solvent, the restriction of temporal economy, a stereoisomer conversion rate, and the molecular weight restriction of the used polymer as well as a big problem of difficulty in uniformly dispersing a clay compound into a polymer. Furthermore, the method for uniformly dispersing a clay compound into a polymer stereoisomer to prepare a clay/biodegradable polymer stereoisomeric nanocomposite has not been reported. Accordingly, there is a need of industry for the method of preparing a clay/biodegradable polymer stereoisomeric nanocomposite with a high strength having an enhanced thermal and mechanical stability required by industries.

On the other hand, carbon dioxide is a supercritical fluid which is widely used due to low critical temperature and pressure, low price, nonflammability and non-toxicity. However, supercritical carbon dioxide has a problem of incapable of dissolving other polymers excluding fluorinated polymers and siloxane polymers.

### SUMMARY OF THE INVENTION

An objective of the present invention is to provide a method for preparing a clay/biodegradable polymer stereoisomeric nanocomposite having a predetermined form such as powder or porous foam with an enhanced thermal and mechanical stability using a simple, economical and eco-friendly supercritical fluid-organic solvent system, thereby solving a problem that a polymer cannot be generally dissolved when only a single supercritical fluid is used in a conventional process or the like.

The method of preparing a clay/polymer composite according to the present invention may include (a) introducing a clay, a biodegradable single-phase D-type/L-type stereoisomeric polymer and an organic solvent into a reactor, (b) introducing a supercritical fluid into the reactor to form a stereoisomeric composite, and forming a clay/polymer composite dispersed with the clay on the stereoisomeric composite, and (c) collecting the clay/polymer composite, and the clay/polymer composite of the present invention is a clay/polymer composite prepared by the foregoing preparation method.

The method of preparing a clay/polymer composite according to the present invention in which a clay and two kinds of single-phase biodegradable polymers are mixed by using a mixture of a compressed gas, which is a supercritical fluid, and an organic solvent as a reaction solvent to prepare a clay/biodegradable polymer stereoisomeric nanocomposite may provide an eco-friendly preparation method capable of using a small amount of organic solvent, implementing a simple preparation process, and substituting a complicated process in the related art.

A clay/biodegradable polymer stereoisomeric nanocomposite prepared by the present invention has an excellent thermal and mechanical stability compared to a composite in the related art, and thus may be advantageously used as engineering plastics, general-purpose plastic substitutes, high-performance medical materials, and the like, which require high strength and thermal stability.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is an X-ray diffraction analysis result graph illustrating a clay/biodegradable polymer stereoisomeric nanocomposite prepared by using a method of the example 1 of the present invention;

FIG. 2 is a thermogravimetric analysis result graph illustrating a thermal stability of the clay/biodegradable polymer stereoisomeric nanocomposite prepared by using a method of the example 1 of the present invention;

FIG. 3 is an X-ray diffraction analysis result graph illustrating a clay/biodegradable polymer stereoisomeric nanocomposite prepared by using a method of the example 2 of the present invention; and

FIG. 4 is an X-ray diffraction analysis result graph illustrating a clay/biodegradable polymer stereoisomeric nanocomposite prepared by using a method of the example 3 of the present invention.

### DETAILED DESCRIPTION OF THE INVENTION

According to the present invention, there is a provided a method of preparing a clay/biodegradable polymer stereoisomeric nanocomposite including putting two kinds of single-phase biodegradable polymers (stereoisomers in L-type and D-type) having different stereostructures, a clay, and a small amount of organic solvent in a reactor, and injecting a supercritical fluid thereinto, and then applying a predetermined temperature and pressure, and uniformly mixing the single-phase polymers and clay to form a stereoisomeric composite and cause a dispersion reaction of the clay, and a clay/biodegradable polymer stereoisomeric nanocomposite having a predetermined form such as a powder or porous sponge prepared by the above method.

The method of preparing a clay/polymer composite according to the present invention may include (a) introducing a clay, a biodegradable single-phase D-type/L-type stereoisomeric polymer and an organic solvent into a reactor, (b) introducing a supercritical fluid into the reactor to form a stereoisomeric composite, and forming a clay/polymer composite dispersed with the clay on the stereoisomeric composite, and (c) collecting the clay/polymer composite. The clay/polymer composite may have the form of a particle or porous foam.

In the clay/polymer composite, the clay particles may be uniformly dispersed into the biodegradable polymer stereoisomeric matrix composite.

The clay may have a layered structure in which oxide layers having a negative charge are laminated to one another, and may be a natural clay or synthetic clay having a thickness of 0.5-1.5 nm and an aspect ratio of 200-2000 for each layer. The aspect ratio represents a horizontal to vertical length ratio as viewed from the top direction by taking a plane of the stereo layered structure into consideration. The form of a plane viewed from the top direction is a long rod shape when the aspect ratio is 200 to 2000.

The clay may be phyllosilicates, sodium phyllosilicates, potassium phyllosilicates, or one for which they are modified with quaternary ammonium ions of the following formula 1,

N⁺R³R⁴R⁵R⁶ <Formula 1>

wherein R³, R⁴, R⁵ and R⁶ are C₁-C₂₅ alkyl independently unsubstituted or substituted by a substituent, respectively, and the substituent is phenyl, hydroxy, amine, epoxy, or carboxy acid.

The phyllosilicate may be any one selected from a group consisting of montmorillonite, hectorite, saponite, beidellite, nontronite, vermiculite, volkonskoite, sauconite, fluorohectorite, magadite, kaolinite, and halloysite.

The biodegradable single-phase D-type/L-type stereoisomeric polymer may be a cyclic ester monomer having a chiral carbon atom, the cyclic ester monomer may be any one selected from a group consisting of lactides, lactones, cyclic carbonates, cyclic anhydrides and thiolactones compounds, and may be a compound of the following formula 2.

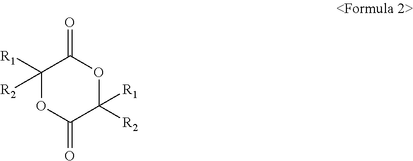

wherein R₁ and R₂ are independently hydrogen or C₁-C₄ alkyl, respectively, in the above formula.

The organic solvent may be any one selected from a group consisting of chloroform, dichloromethane, dioxane, toluene, xylene, ethyl benzene, dichloroethylene, dichloroethane, trichloroethylene, chlorobenzene, dichlorobenzene, tetrahydrofuran, dibenzyl ether, dimethyl ether, acetone, methylethyl ketone, cyclohexanone, acetophenone, methyl isobutyl ketone, isophorone, diisobutil ketone, methyl acetate, ethyl formate, ethyl acetate, diethyl carbonate, diethyl sulfate, butyl acetate, diacetone alcohol, diethyl glycol monobutyl ether, decanol, benzoic acid, stearic acid, tetrachloroethane, hexafluoroisopropanol, hexafluoroacetone sesquihydrate, acetonitrile, chlorodifluoromethane, trifluoroethane, difluoroethane and their mixtures.

1 to 50 parts by weight of the biodegradable single-phase D-type/L-type stereoisomeric polymer may be introduced for every 100 parts by weight of solvent. 0.5-100 parts by weight of the organic solvent may be introduced for every 100 parts by weight of the supercritical fluid.

1 to 100 parts by weight of a clay in step (a) may be introduced for every 100 parts by weight of the polymer, and subsequent to the step (a), the method may further include (a′) mixing the clay, the polymer and the organic solvent to form a master batch.

The supercritical fluid may be any one compressed gas selected from a group consisting of carbon dioxide (CO₂), dichlorotrifluoroethane (HFC-23), difluoromethane (HFC-32), difluoroethane (HFC-152a), trifluoroethane (HFC-143a), tetrafluoroethane (HFC-134a), pentafluoroethane (HFC-125), heptafluoropropane (HFC-227ea), hexafluoropropane (HFC-236fa), pentafluoropropane (HFC-245fa), sulfur hexafluoride (SF6), perfluorocyclobutane (C-318), dichlorofluoroethane (HCFC-1416), chlorodifluoroethane (HCFC-1426), chlorofluoromethane (HCFC-22), dimethyl ether, nitrogen dioxide (NO₂), propane, butane, and their mixtures.

A reaction temperature in step (b) may be 25 to 250° C., and a reaction pressure therein may be 40 to 700 bar, and the reaction in step (b) may be carried out for 5 minutes to 15 hours.

Steps (a) through (c) may be progressed in a batch manner or in a sequential manner.

The collection of the clay/polymer composite in step (c) may be collected by injecting a solution containing the clay/polymer composite, and the porosity and pore size of a clay/composite in the form of a porous foam may be controlled by controlling the injection speed and pressure.

A clay/polymer composite according to the present invention may be prepared by using any one of the foregoing methods.

Hereinafter, the present invention will be described in detail.

In a method of preparing a clay/polymer composite (clay/biodegradable polymer stereoisomeric nanocomposite) according to the present invention, biodegradable polymer materials having different two kinds of single-phases are dissolved and uniformly mixed by using a supercritical fluid, which is a compressed gas and a small amount of organic solvent as a reaction solvent, and crystallization is caused by applying a predetermined temperature and pressure to form a polymer stereoisomeric composite, and a nano-sized clay is used as a filler to prepare a clay/biodegradable polymer stereoisomeric nanocomposite in which the nano-sized clay is uniformly dispersed into a polymer stereoisomeric matrix composite.

When a polymer monomer has chiral carbon atoms, it has an L-type (R-) and D-type (S-) isomeric polymer. The monomer maintains the chirality even after being formed as a polymer, and a mixture uniformly mixed with a polymer made of a D-type monomer and a polymer made of a L-type monomer forms a stereoisomeric composite (stereocomplex) made of a new type of crystalline structure. A polymer stereoisomeric composite in the present invention represents such a polymer stereoisomeric composite. The polymer stereoisomeric composite may typically have a melting point higher than that of a single-phase polymer, thereby enhancing thermal durability.

Furthermore, clay/polymer nanocomposite in the present invention represents a biodegradable matrix polymer such as oligomer, polymer, or their blends, exfoliated and intercalated type platelets of a clay compound having a nano-sized layered structure, an exfoliate (exfoliated nanocomposite) dispersed with platelets, or a layered type intercalator (tactoidal nanocomposite) or a composite dispersed with their mixture.

Here, exfoliate represents a composite having a laminate thickness of less than 140 nm, preferably, less than 10 nm in which a matrix polymer, an aqueous solution or a polymer material is inserted into adjacent thin layers of a layered clay compound to widen an interlayer distance therebetween above at least 5 Å, preferably, above 10 Å but the thin layers are not completely exfoliated by the interlayer insertion. Intercalating carrier used for the intercalation represents a material capable of inducing intercalation such as water, a mixture of water and an organic solvent, and the like. Furthermore, matrix polymer represents a compound having a size of about 10 Å, representing a medium constituting a nanocomposite dispersed with exfoliates or intercalators, and platelets represents each layer of the layered compound.

Clay/biodegradable polymer stereoisomeric nanocomposite in the present invention represents a composite in which a clay compound having a nano-sized layered structure as described above is used as a filler, and a polymer stereoisomer becomes a medium and thus clay particles are uniformly distributed over the polymer stereoisomer.

Furthermore, supercritical fluid in the present invention is defined by a material above a critical temperature (T_{c}) and a critical pressure (P_{c}). All pure gases have a critical temperature (T_{c}) at which the gas cannot be liquefied even when increasing pressure, and a critical pressure (P_{c}) required to liquefy the gas again at the critical temperature. A supercritical fluid above such a critical temperature and critical pressure has properties similar to a gas as well as having solubility similar to a liquid, thereby substituting an incompressible organic solvent.

One of important advantages of using a supercritical fluid in a sequential manner for polymer reaction is to control the properties of a solvent such as dielectric constant or the like by simply changing the temperature and pressure of a system, thereby controlling the solubility of a polymer. However, carbon dioxide as a supercritical fluid is a frequently used supercritical fluid due to low supercritical temperature and pressure, low cost, non-flammability and non-toxicity, but has a limit incapable of dissolving polymers excluding fluorine-based or silicon-based polymers. In particular, it has been known that polyester-based biodegradable polymers such as polylactide are hardly dissolved in supercritical carbon dioxide. Instead, it is used as an antisolvent when preparing polymer particles using a supercritical fluid precipitation method. Polylactide is not completely dissolved in pure supercritical carbon dioxide even at a pressure above 80 mPa and a temperature above 373.15 K.

On the contrary, various organic solvents such as chloroform, dichloromethane, dioxane can dissolve polyester-based biodegradable polymers. By using this property, a small amount of organic solvent may be applied to supercritical carbon dioxide to increase the solubility of a polymer, and it may be caused by an interaction between a dipole moment of the organic solvent and a dipole moment of an ester group of the polyester-based biodegradable polymer.

The method for preparing a polyester-based biodegradable clay/biodegradable polymer stereoisomeric nanocomposite having a predetermined form such as powder or porous foam using a supercritical fluid-organic solvent system will be described in detail as follows.

First, a nano-sized clay and two kinds of D-type and L-type single-phase polyester-based polymer isomeric composites, and an organic solvent are added to a reactor and then a supercritical fluid which is a compressed gas as a reaction solvent is injected to mix them in the range of temperatures of 25 to 250° C., preferably, 35 to 150° C., and pressures of 40 to 700 bar, preferably, 150 to 450 bar to form the single-phase polyester-based polymer as a polymer stereoisomeric composite, thereby obtaining a clay/biodegradable polymer stereoisomeric nanocomposite in which a nano-sized clay compound is uniformly dispersed into a polymer stereoisomeric matrix composite.

When the reaction pressure is less than 40 bar, the amount of a single-phase polymer allowed to be put into a reactor is reduced, thereby causing a problem of decreasing the amount of the obtained clay/biodegradable polymer stereoisomeric nanocomposite. Furthermore, when the reaction pressure exceeds 700 bar, it is unpreferable because the equipment cost and operation cost of an overall reaction system is drastically increased due to extra high pressure.

When the reaction temperature is less than 25° C., it cannot exceed a critical point of carbon dioxide gas, and thus the formation of supercritical carbon dioxide may be deteriorated. When exceeding 150° C., the pyrolysis of a polymer is carried out, thereby decreasing a generation rate of the clay/biodegradable polymer stereoisomeric nanocomposite. As a result, the reaction temperature may be preferably 25 to 150° C.

In case of the reaction time, the generation of a clay/biodegradable polymer stereoisomeric nanocomposite reaches 100% within 15 hours, and pyrolysis may be carried out as increasing the time, and thus the reaction time may be preferably 5 minutes to 15 hours. More preferably, the reaction time is 1 to 10 hours.

The examples of a supercritical fluid used in the present invention may include compressed gases such as carbon dioxide (CO₂), dichlorotrifluoroethane (HFC-23), difluoromethane (HFC-32), difluoroethane (HFC-152a), trifluoroethane (HFC-143a), tetrafluoroethane (HFC-134a), pentafluoroethane (HFC-125), heptafluoropropane (HFC-227ea), hexafluoropropane (HFC-236fa), pentafluoropropane (HFC-245fa), sulfur hexafluoride (SF6), perfluorocyclobutane (C-318), dichlorofluoroethane (HCFC-1416), chlorodifluoroethane (HCFC-1426), dimethyl ether, nitrogen dioxide (NO₂), propane, butane, and their mixtures.

For the injection of a supercritical fluid in the present invention, a gas such as carbon dioxide or the like may be passed through a freezer to be completely liquefied and then pressurized by using a high pressure liquid pump, thereby allowing a compressed gas such as liquid carbon dioxide to be put therein.

The examples of an organic solvent used as a supercritical fluid-organic solvent system in the present invention may include chloroform, dichloromethane, dioxane, toluene, xylene, ethyl benzene, dichloroethylene, dichloroethane, trichloroethylene, chlorobenzene, dichlorobenzene, tetrahydrofuran, dibenzyl ether, dimethyl ether, acetone, methylethyl ketone, cyclohexanone, acetophenone, methyl isobutyl ketone, isophorone, diisobutil ketone, methyl acetate, ethyl formate, ethyl acetate, diethyl carbonate, diethyl sulfate, butyl acetate, diacetone alcohol, diethyl glycol monobutyl ether, decanol, benzoic acid, stearic acid, tetrachloroethane, hexafluoroisopropanol, hexafluoro acetone sesquihydrate, acetonitrile, chlorodifluoromethane, trifluoroethane, difluoroethane and their mixtures.

Furthermore, a nano-sized clay used as a filler in the present invention may be a clay mineral having a layered structure in which oxide layers having a negative charge are laminated to one another, and may be a natural clay or synthetic clay having a thickness of about 1 nm, a length of about 2180 Å, and an aspect ratio of about 2000 for each layer. More specifically, a clay compound used in the present invention may be phyllosilicates having a negative charge made of aluminium silicate or magnesium silicate layers, or potassium or sodium phyllosilicates filled with sodium ions (Na+) or potassium ions (K+) between phyllosilicate layers, and they can be easily purchased from the market. The phyllosilicates used in the present invention may be preferably selected from selected from montmorillonite, hectorite, saponite, beidellite, nontronite, vermiculite, volkonskoite, sauconite, fluorohectorite, magadite, kaolinite, and halloysite.

According to the present invention, furthermore, a clay in which the phyllosilicates, sodium phyllosilicates, potassium phyllosilicates, or the like are treated with quaternary ammonium ions expressed by the formula 1 may be used as a filler, and such clay minerals treated with quaternary ammonium ions may be purchased from the market (for example, Cloisite 30B, Cloisite 25A, etc.), or clay minerals may be treated with an organic modifier such as quaternary ammonium ions or the like according to a method publicly-known in the art such as U.S. Pat. Nos. 4,810,734, 4,889,885, 4,894,411 and 5,385,776 to be prepared and then used.

When a clay mineral is treated with an organic matter such as organic ammonium ions as described above, the organic matter will increase an interlayer distance between thin layers. As a result, if an organic clay mineral treated with organic ammonium ions is kneaded with a high shear stress, then each plate of the clay mineral will be separated to be uniformly dispersed into a matrix polymer.

According to the present invention, when a mixture of supercritical fluid and organic solvent is used as a reaction solvent, for the ratio of parts by weight of a single-phase polymer injected at an initial stage, 1-50 parts by weight may be preferable based on total 100 parts by weight of solvent. When the ratio of the used single-phase polymer is less than 1 part by weight, the efficiency of a solvent mixing system may be reduced and thus it may be difficult to maintain the shape of a clay/biodegradable polymer stereoisomeric nanocomposite produced in the form of a powder or porous foam. When exceeding 50 parts by weight, a generation rate of the clay/biodegradable polymer stereoisomeric nanocomposite may be reduced and it may have a high possibility of forming a non-uniform fine powder and porous foam, thereby causing a problem.

Furthermore, according to the present invention, for a weight ratio of organic solvent to supercritical fluid, 0.5 to 100 parts by weight may be preferable based on 100 parts by weight of the supercritical fluid. An organic solvent with less than 0.5 part by weight may have an insignificant effect of increasing solubility by the organic solvent in a mixture system with a supercritical fluid, and thus have a very low generation rate of the clay/biodegradable polymer stereoisomeric nanocomposite, thereby showing a result very similar to a case when the organic solvent is not used. Furthermore, when the ratio of the organic solvent is larger than 100 parts by weight, a result is shown that toxicity to the remaining organic solvent offsets an advantage of eco-friendly supercritical fluid.

The amount of a clay used as a filler may be preferably in a range of 1 to 100 parts by weight based on the weight of a cyclic ester monomer, and master batches greater than 10 parts by weight can be made based on part by weight of a monomer by increasing the amount of a filler. If a clay and a polymer are mixed by using a roll mill, a mixing chamber, a polymer extruder, and the like to prepare master batches and applied to a preparation method according to the present invention, then a clay/biodegradable polymer stereoisomeric nanocomposite can be more uniformly prepared compared to a case of direct mixture in a supercritical fluid process.

A reactor according to the present invention may be a high-pressure reactor sealed with a high pressure of about 350 bar, which is attached to a proportional-integral-differential temperature controller, a thermometer, a heater, a pressure gauge, a safety valve, and a stirrer capable of stirring a reactant that is accompanied by a speed controller and a tachometer for measuring the speed.

The supercritical fluid injection process may be carried out in a batch operation or sequentially, and the injected compressed gas can completely dissolve the injected single-phase polymer and the generated clay/biodegradable polymer stereoisomeric nanocomposite to be uniformly reacted.

A biodegradable polymer used in the present invention may be preferably a polymer polymerized from a cyclic ester monomer, and more preferably a kind of biodegradable polyester such as aliphatic polyester, copolymer polyester or the like. In this case, one of more kinds of monomers of polymer may be selected from lactides, lactones, cyclic carbonates, cyclic anhydrides and thiolactones compounds, and it may be applicable when those monomers have chiral carbons.

One or more kinds of the cyclic ester monomers selected from compounds expressed as the above formula 2 may be more preferably used, and a lactide among the compounds of formula 2 may be most preferably used.

In the present invention, a generation rate of the clay/biodegradable polymer stereoisomeric nanocomposite may be controlled by a kind of reactive supercritical fluid, a kind of mixed organic solvent, a total concentration of solvent, a weight ratio of fluid to organic solvent, a reaction temperature, a reaction pressure, a pressure, a reaction time, and the like.

If a mixed reaction is completed as described above, then a product within the reactor may be ejected in the atmosphere to collect clay/biodegradable polymer stereoisomeric nanocomposite particles. Furthermore, if an internal pressure of the reactor is reduced while controlling an injection speed of the supercritical fluid and solvent after finishing reaction within the reactor, then it may be possible to obtain a clay/biodegradable polymer stereoisomeric nanocomposite having various porosities and pore sizes.

If a biodegradable clay/biodegradable polymer stereoisomeric nano-composite is prepared according to a method of the present invention, then there exists no residual organic solvent within the composite, and thus it is eco-friendly because the residual organic solvent is not necessarily removed and the solvent used in the reaction can be collected to be used again. Furthermore, a clay/biodegradable polymer stereoisomeric nanocomposite powder or foam of a high-molecular biodegradable polyester can be formed without putting a separate stabilizer therein, and thus a clay/biodegradable polymer stereoisomeric nanocomposite having a thermal stability and high strength can be prepared by a single continuous process in a simple manner and at low cost. Furthermore, a clay/biodegradable polymer stereoisomeric nanocomposite obtained according to the present invention has hardly residual organic solvent and has good physical properties, and thus has highly likelihood to be used for general and medical materials, and also can be used as engineering plastics, general-purpose plastic substitutes, high-performance medical materials, and the like, which require high strength and thermal stability.

### EXAMPLES

Hereinafter, the present invention will be described in more detail through examples. However, the examples are provided only to illustrate the present invention, but the present invention will not be limited to them.

### Example 1

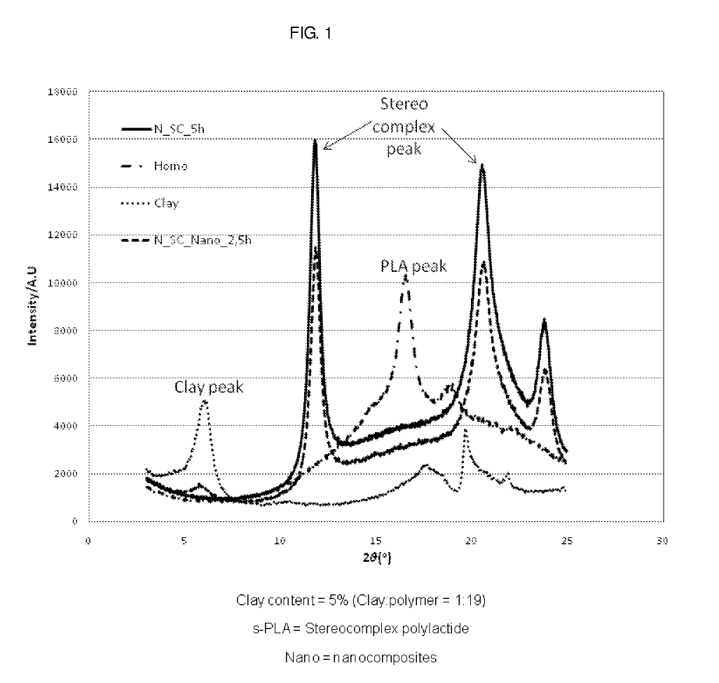

Poly L-lactide (weight 0.84 g, average molecular weight 50,000) and poly D-lactide dissolved at 1:1 into 3.89 ml of dichloromethane, respectively, were injected into a 40 ml high-pressure reactor. 84 mg of fluorinated clay (self made) corresponding to a ratio of 5% weight to total weight of polymer was injected herein. The weight ratio of a total amount of polymer to a total amount of solvent (supercritical carbon dioxide (weight ratio 70) and dichloromethane (weight ratio 30)) was 5:100. Then, carbon dioxide was pressurized and injected into the high-pressure reactor using a high-pressure liquid pump. Then, the reactor was gradually heated and pressurized to reach an internal temperature 65° C. and an internal pressure of 350 bar, respectively. When the temperature and pressure became constant, they were stirred for 5 hours to carry out the reaction, and when the reaction was completed, then the reactor was immediately opened to obtain a clay/biodegradable polymer stereoisomeric nanocomposite in the form of a powder. An X-ray diffraction analysis was carried out to determine whether or not a composite was formed in the clay/biodegradable polymer stereoisomeric nanocomposite prepared by the present invention. Poly D-lactide had a right-handed helical structure, and poly L-lactide had a left-handed helical structure and thus a uniform mixture of two polymers formed a layered structure, thereby having a parallel structure in which they were stacked one by one in a parallel manner. As a result, the X-ray diffraction results are different when the helical structure and crystalline structure are a single-phase polymer and a stereoisomeric composite. In case of the clay having a nano-sized layered structure, a polymer is placed between thin layers to increase an interlayer distance thereof and thus every plate is separated from one another and uniformly distributed into a matrix polymer, and accordingly, an X-ray diffraction peak of the clay is disappeared. It is shown in FIG. 1.

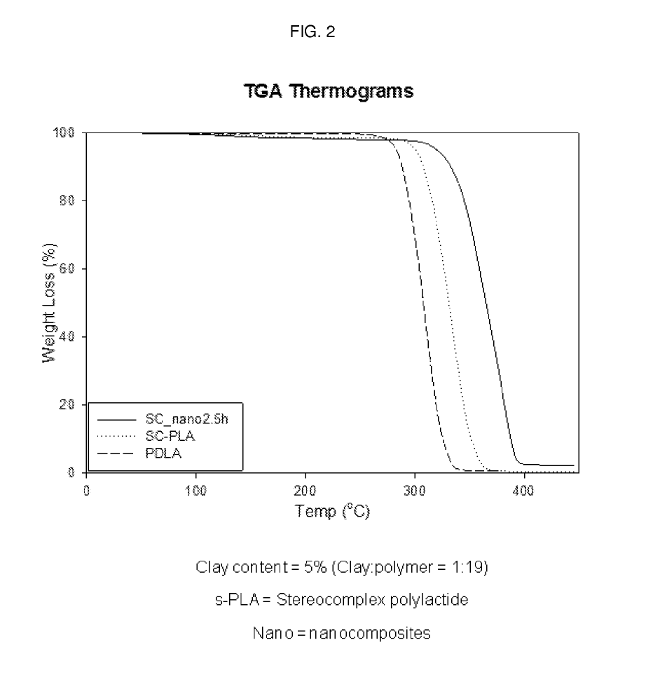

As a result of performing a thermal weight analysis to measure the thermal stability of the clay/polylactide stereoisomeric nanocomposite prepared in Example 1, it was confirmed that pyrolysis in case of the clay/polylactide stereoisomeric nanocomposite was carried out at a temperature 40° C. higher than the case of a pure polylactide stereoisomeric nanocomposite containing no clay, and 80° C. higher than the case of a pure poly D-lactide (FIG. 2).

### Example 2

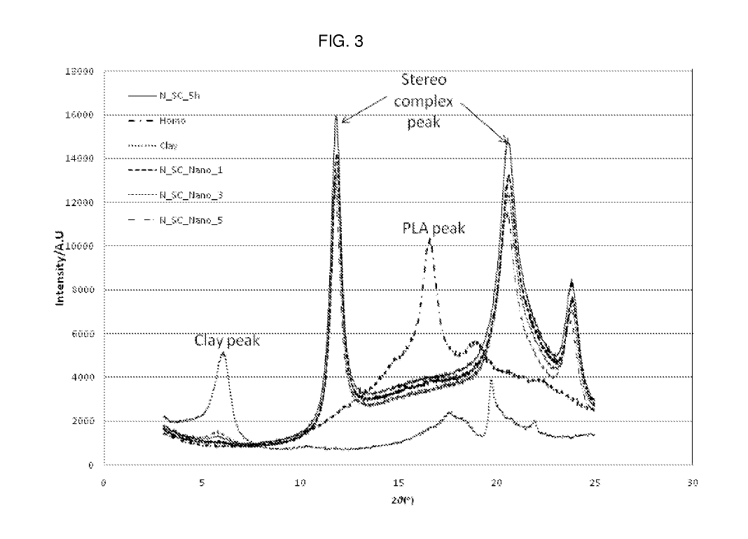

Poly L-lactide (weight 0.84 g, average molecular weight 50,000) and poly D-lactide dissolved at 1:1 into 3.89 ml of dichloromethane, respectively, were injected into a 40 ml high-pressure reactor. 16.8 mg, 50.4 mg, and 84 mg of fluorinated clay (self made) corresponding to a ratio of 1%, 3%, and 5% weight to total weight of polymer were injected herein. The weight ratio of a total amount of polymer to a total amount of solvent (supercritical carbon dioxide (weight ratio 70) and dichloromethane (weight ratio 30)) was 5:100. Then, carbon dioxide was pressurized and injected into the high-pressure reactor using a high-pressure liquid pump. Then, the reactor was gradually heated and pressurized to reach an internal temperature 65° C. and an internal pressure of 350 bar, respectively. When the temperature and pressure became constant, they were stirred for 5 hours to carry out the reaction, and when the reaction was completed, then the reactor was immediately opened to obtain a clay/biodegradable polymer stereoisomeric nanocomposite in the form of a powder. An X-ray diffraction analysis was carried out to determine whether or not a composite was formed in the clay/biodegradable polymer stereoisomeric nanocomposite according to various amounts of clay using the present invention, and it was confirmed that clay/stereoisomeric polylactide was well formed with respect to various amounts of clay (FIG. 3).

### Example 3

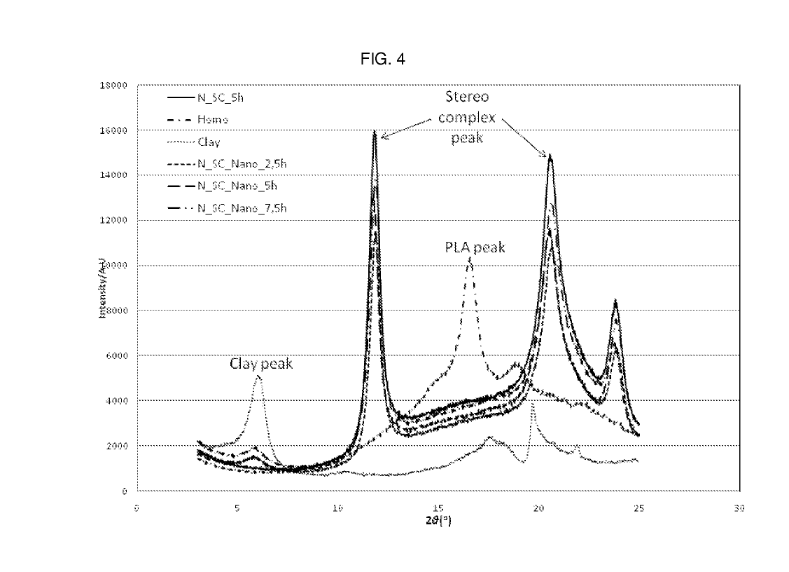

Poly L-lactide (weight 0.84 g, average molecular weight 50,000) and poly D-lactide dissolved at 1:1 into 3.89 ml of dichloromethane, respectively, were injected into a 40 ml high-pressure reactor. 42 mg of fluorinated clay (self made) corresponding to a ratio of 5% weight to total weight of polymer were injected herein. The weight ratio of a total amount of polymer to a total amount of solvent (supercritical carbon dioxide (weight ratio 70) and dichloromethane (weight ratio 30)) was 5:100. Then, carbon dioxide was pressurized and injected into the high-pressure reactor using a high-pressure liquid pump. Then, the reactor was gradually heated and pressurized to reach an internal temperature 65° C. and an internal pressure of 350 bar, respectively. When the temperature and pressure became constant, they were stirred for 2.5 hours, 5 hours, and 7 hours to carry out the reaction, and when the reaction was completed, then the reactor was immediately opened to obtain a clay/biodegradable polymer stereoisomeric nanocomposite in the form of a powder. An X-ray diffraction analysis was carried out to determine whether or not a composite was formed in the clay/biodegradable polymer stereoisomeric nanocomposite according to various reaction times using the present invention, and it was confirmed that clay/stereoisomeric polylactide was well formed with respect to various reaction times (FIG. 4).

1. A method of preparing a clay/polymer composite, the method comprising:
(a) introducing a clay, a biodegradable single-phase D-type/L-type stereoisomeric polymer and an organic solvent into a reactor;
(b) introducing a supercritical fluid into the reactor to form a stereoisomeric composite, and forming a clay/polymer composite dispersed with the clay on the stereoisomeric composite; and
(c) collecting the clay/polymer composite.

2. The method of claim 1, wherein the clay/polymer composite has the form of a particle or porous foam.

3. The method of claim 1, wherein the clay particles are uniformly dispersed into the biodegradable polymer stereoisomeric matrix composite in the clay/polymer composite.

4. The method of claim 1, wherein the clay has a layered structure in which oxide layers having a negative charge are laminated to one another, and is a natural clay or synthetic clay having a thickness of 0.5-1.5 nm and an aspect ratio of 200-2000 for each layer.

5. The method of claim 1, wherein the clay is phyllosilicates, sodium phyllosilicates, potassium phyllosilicates, or one for which they are modified with quaternary ammonium ions of the following formula 1,
N⁺R³R⁴R⁵R⁶ <Formula 1>
wherein R³, R⁴, R⁵ and R⁶ are C₁-C₂₅ alkyl independently unsubstituted or substituted by a substituent, respectively, and the substituent is phenyl, hydroxy, amine, epoxy, or carboxy acid.

6. The method of claim 5, wherein the phyllosilicate is any one selected from a group consisting of montmorillonite, hectorite, saponite, beidellite, nontronite, vermiculite, volkonskoite, sauconite, fluorohectorite, magadite, kaolinite, and halloysite.

7. The method of claim 1, wherein the biodegradable single-phase D-type/L-type stereoisomeric polymer is a cyclic ester monomer having a chiral carbon atom.

8. The method of claim 7, wherein the cyclic ester monomer is any one selected from a group consisting of lactides, lactones, cyclic carbonates, cyclic anhydrides and thiolactones compounds.

9. The method of claim 7, wherein the cyclic ester monomer is a compound of the following formula 2. 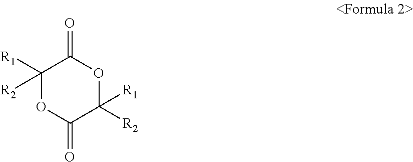
wherein R₁ and R₂ are independently hydrogen or C₁-C₄ alkyl, respectively, in the above formula.

10. The method of claim 1, wherein the organic solvent is any one selected from a group consisting of chloroform, dichloromethane, dioxane, toluene, xylene, ethyl benzene, dichloroethylene, dichloroethane, trichloroethylene, chlorobenzene, dichlorobenzene, tetrahydrofuran, dibenzyl ether, dimethyl ether, acetone, methylethyl ketone, cyclohexanone, acetophenone, methyl isobutyl ketone, isophorone, diisobutil ketone, methyl acetate, ethyl formate, ethyl acetate, diethyl carbonate, diethyl sulfate, butyl acetate, diacetone alcohol, diethyl glycol monobutyl ether, decanol, benzoic acid, stearic acid, tetrachloroethane, hexafluoroisopropanol, hexafluoroacetone sesquihydrate, acetonitrile, chlorodifluoromethane, trifluoroethane, difluoroethane and their mixtures.

11. The method of claim 1, wherein 1 to 50 parts by weight of the biodegradable single-phase D-type/L-type stereoisomeric polymer are introduced for every 100 parts by weight of solvent.

12. The method of claim 1, wherein 0.5-100 parts by weight of the organic solvent are introduced for every 100 parts by weight of the supercritical fluid.

13. The method of claim 1, wherein 1 to 100 parts by weight of a clay in step (a) are introduced for every 100 parts by weight of the polymer, and subsequent to the step (a), the method further comprises:
(a′) mixing the clay, the polymer and the organic solvent to form a master batch.

14. The method of claim 1, wherein the supercritical fluid is any one compressed gas selected from a group consisting of carbon dioxide (CO₂), dichlorotrifluoroethane (HFC-23), difluoromethane (HFC-32), difluoroethane (HFC-152a), trifluoroethane (HFC-143a), tetrafluoroethane (HFC-134a), pentafluoroethane (HFC-125), heptafluoropropane (HFC-227ea), hexafluoropropane (HFC-236fa), pentafluoropropane (HFC-245fa), sulfur hexafluoride (SF6), perfluorocyclobutane (C-318), dichlorofluoroethane (HCFC-1416), chlorodifluoroethane (HCFC-1426), chlorofluoromethane (HCFC-22), dimethyl ether, nitrogen dioxide (NO₂), propane, butane, and their mixtures.

15. The method of claim 1, wherein a reaction temperature in step (b) is 25 to 250° C., and a reaction pressure therein is 40 to 700 bar.

16. The method of claim 1, wherein the reaction in step (b) is carried out for 5 minutes to 15 hours.

17. The method of claim 1, wherein steps (a) through (c) are progressed in a batch manner or in a sequential manner.

18. The method of claim 1, wherein the collection of the clay/polymer composite in step (c) is collected by injecting a solution containing the clay/polymer composite, and the porosity and pore size of a clay/composite in the form of a porous foam are controlled by controlling the injection speed and pressure.

19. A clay/polymer composite prepared by using the methods of claim 1.
